(19) United States
(12) Patent Application Publication
(10) Pub. No.: US 2008/0205677 A1
(43) Pub. Date: Aug. 28, 2008

(54) Hearing apparatus with interference signal separation and corresponding method

(75) Inventors: Robert Bauml, Eckental (DE); Andreas Tiefenau, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISCHE TECHNIK GmbH

(21) Appl. No.: 12/070,483

(22) Filed: Feb. 19, 2008

(30) Foreign Application Priority Data
Feb. 22, 2007 (DE) 10 2007 008 739.1

(51) Int. Cl. H04R 25/00

(52) U.S. Cl. 381/312

(57) ABSTRACT

The perceptibility of a useful signal during the binaural supply of a user is to be improved. To this end, a hearing apparatus with at least one microphone is proposed to pick up an input signal, which has a useful sound and an interference sound. An interference signal estimation device is used to estimate the interference sound in the input sound. A signal processing device provides a first output signal on the basis of the estimated interference sound for the one ear of the user and a second output signal on the basis of the estimated interference sound for the other ear of the user. The second output signal is provided with a predetermined time offset compared with the first output signal. A virtual local displacement of the interference signal source thus results so that the useful signal can be better perceived.

The present invention relates to a hearing apparatus for the binaural supply of a user with at least one microphone for picking up an input sound, which has a useful sound and an interference sound. Furthermore, the present invention relates to a corresponding method for binaural supply. The term hearing apparatus is understood here to mean in particular a hearing device, but also a headset, earphones or suchlike.

Hearing devices are portable hearing apparatuses which are used to supply the hard-of-hearing. To accommodate the numerous individual requirements, different configurations of hearing devices such as behind-the-ear hearing devices (BTE), in-the-ear hearing devices (ITE), e.g. including conch hearing devices or channel hearing devices (CIC), are provided. The hearing devices given as examples are worn on the outer ear or in the auditory canal. Furthermore, bone conduction hearing aids, implantable or vibrotactile hearing aids are also available on the market. With such devices the damaged hearing is either stimulated mechanically or electrically.

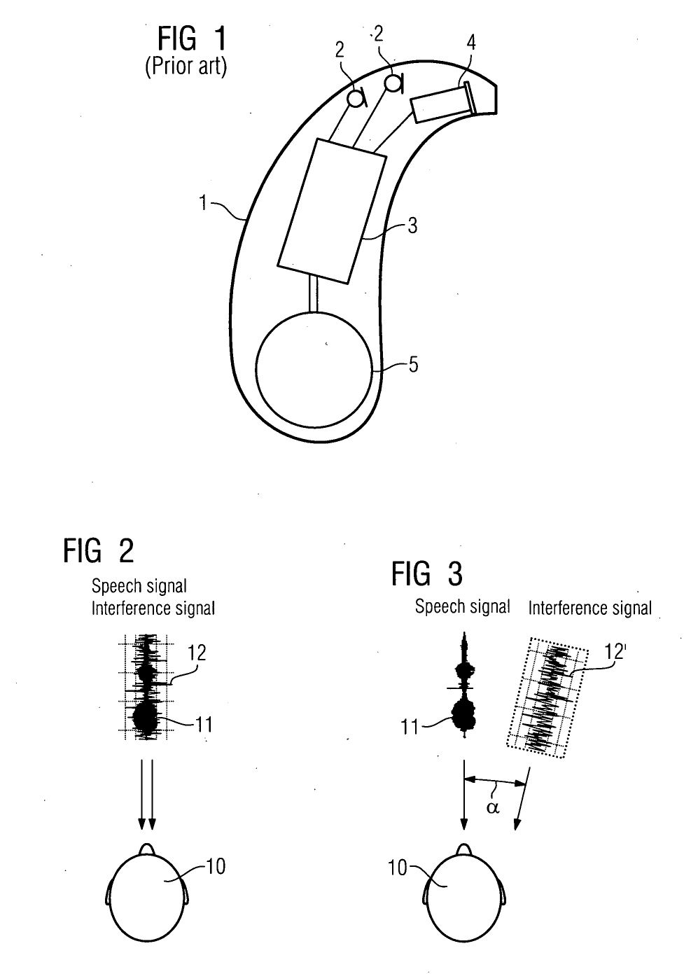

The essential components of the hearing devices are basically an input converter, an amplifier and an output converter. The input converter is generally a receiving transducer, e.g. a microphone and/or an electromagnetic receiver, e.g. an induction coil. The output converter is mostly realized as an electroacoustic converter, e.g. a miniature loudspeaker, or as an electromechanical converter, e.g. a bone conduction receiver. The amplifier is usually integrated into a signal processing unit. This basic configuration is shown in the example in FIG. 1 of a behind-the-ear hearing device. One or more microphones 2 for picking up the ambient sound are incorporated in a hearing device housing 1 to be worn behind the ear. A signal processing unit 3, which is similarly integrated into the hearing device housing 1, processes the microphone signals and amplifies them. The output signal of the signal processing unit 3 is transmitted to a loudspeaker and/or receiver 4, which outputs an acoustic signal. The sound is optionally transmitted to the ear drum of the device wearer via a sound tube, which is fixed with an otoplastic in the auditory canal. The power supply of the hearing device and in particular of the signal processing unit 3 is provided by a battery 5 which is likewise integrated into the hearing device housing 1.

Modern hearing devices can frequently recognize interference noises. The recognition is undertaken for instance on the basis of the stationarity of signal components. Once the interference noises are recognized, they can be suppressed by the interference noise suppression mechanism which is used in each instance. However, artifacts frequently occur during interference noise suppression. So-called “musical tones” develop for instance as a result of the removal and insertion of spectral components. Furthermore, the signal is alienated as a result of many interference noise reduction algorithms, thereby causing the sound quality to suffer.

Artifacts and signal alienations have previously been countered in current hearing devices by attempting to eliminate and/or suppress them as a far as possible. Only a restricted reduction in the interference noises and/or a restricted change in speed of the attenuation occurred for instance within the scope of interference noise suppression.

The article by ANEMÜLLER, Jörn: “Blinde Quellentrennung als Vorverarbeitung zur robusten Sprecherkennung”, [Blind source separation as a pre-processing step for robust speech recognition], in DAGA 2000, Oldenburg describes how the quality of speech recognition can be improved by “Blinde Quellentrennung”, [Blind source separation]. In this way, an interference signal is filtered from an input signal, which is picked up with two microphones, so that only the desired speech signal remains.

The publication EP 1 640 972 A1 also discloses a method for separating the speech of a user from ambient noises. To this end, a device is used which is worn on the ear and has a first microphone directed outwards and a second microphone directed inwards into the ear canal. A speech signal of the user can be obtained from the two input signals as a result of blind source separation, in order to transmit said signal to a receiver wirelessly.

The object of the present invention consists in improving the perception of useful sound in interference sound.

In accordance with the invention, this object is achieved by a hearing apparatus for the binaural supply of a user with at least one microphone for picking up an input sound, which has a useful sound and an interference sound, an interference signal estimation device for estimating the interference sound in the input sound and a signal processing device for providing a first output signal on the basis of the interference sound estimation for the one ear of the user and a second output signal on the basis of the interference sound estimation for the other ear of the user, with the second output signal being provided with a predeterminable time offset compared with the first output signal.

Furthermore, provision is made in accordance with the invention for a method for the binaural supply of a user by picking up an input sound, which has a useful sound and an interference sound, estimating the interference sound in the input signal and providing a first output signal on the basis of the estimated interference signal for the one ear of the user and a second output signal on the basis of the estimated interference sound for the other ear of the user, with the second output signal being provided with a predeterminable time offset compared with the first output signal.

The present invention is based on the idea of basically handling interference signals differently from the way in which they are handled in usual interference noise reduction methods. The interference signal is not to be removed from the overall signal. Instead, only the spatial localization of the interference signal is changed. This avoids artifacts and the sound image is largely retained.

The interference signal estimation device preferably has a speech recognition unit, so that the interference signal is able to be estimated by subtracting a recognized speech signal as a useful signal from the input sound. In this process the useful signal is thus primarily estimated and the interference signal is estimated indirectly from it. This type of estimation of the interference signal is frequently advantageous if the useful signal is known.

The interference signal estimation device may be able to estimate an interference signal component in a number of frequency bands in each instance. In many cases, this interference signal handling in bands enables better results to be achieved.

The hearing apparatus according to the invention can also comprise a directional microphone, with which interference sound components which do not originate from a useful sound direction can be attenuated. The hearing apparatus according to the invention and/or the method according to the invention can however also be combined with any other interference noise suppression measures. This produces a usual attenuation of an interference noise together with its spatial displacement for instance.

The present invention is described in more detail with reference to the appended drawings, in which;

FIG. 1 shows a conventional design of a hearing device according to the prior art and

FIG. 2 shows a diagram for perceiving a disturbed speech signal and

FIG. 3 shows a diagram for perceiving the disturbed speech signal according to a virtual local displacement of the interference source.

The exemplary embodiment explained in more detail below represents a preferred embodiment of the present invention.

In accordance with the example in FIG. 2, a hearing device wearer 10 perceives a useful signal 11, here a speech signal, from a useful signal direction. The hearing device wearer also hears an interference signal from this useful signal direction. This greatly restricts the comprehensibility of the speech in the present example.

As is conventional with modern hearing devices, the interference noise is now estimated by the hearing devices (not shown in FIG. 2) in different frequency bands. If the estimation determines that the interference noise component predominates in a band, an interference noise separation algorithm generates a temporal offset between the signals on the right and left side. In accordance with FIG. 3, this produces a virtual local displacement of the interference signal source by an angle α. This means that the speech signal 11 is perceived as before from the useful signal direction, an estimated interference signal 12′ however from another direction.

The temporal offset of the signals on the left and right ear by the left and right hearing device thus results in a displacement of the spatial localization. As a result, the separation of the interference signal 12, 12′ and useful signal 11 is assisted in the central processing (auditory system), since the signal parts are mapped in different regions of the auditory cortex (human hearing system).

In accordance with an alternative embodiment, the interference noise separation is carried out without separate analysis in several frequency bands. The separation is carried out here by a known type of useful signal. A speech signal is separated from a residual signal over a wide band for instance. A speech signal is determined by means of a speech recognition algorithm and the recognized speech signal is then subtracted from the overall signal, thereby producing a residual signal, in other words an indirectly estimated interference signal. The speech signal is separated from the residual signal in that the speech signal remains untouched in terms of its spatial information while the residual signal is displaced locally horizontally by about 10 to 20 degrees. The displacement is carried out as above by temporally offsetting the two signals determined for the left and right ear. The human brain is then able to better understand the speech signal, since the interference noise is perceived from another direction.

1.-8. (canceled)

9. A hearing apparatus for a binaural supply of a user, comprising:
a microphone for picking up an input sound, wherein the input sound has a useful sound and an interference sound;
an interference signal estimation device to estimate the interference sound in the input sound; and
a signal processing device to provide:
a first output signal from a interference sound estimation for a ear of the user, and
a second output signal from the interference sound estimation for a further ear of the user, wherein the second output signal is provided with a predeterminable time offset compared with the first output signal.

10. The hearing apparatus as claimed in claim 9, wherein the interference signal estimation device has a speech recognition device unit, so that the interference signal can be estimated by a recognized speech signal as a useful sound being subtracted from the input signal.

11. The hearing apparatus as claimed in claim 9, wherein the interference signal estimation device estimates an interference signal component in a plurality of frequency bands in each instance.

12. The hearing apparatus as claimed in claim 10, wherein the interference signal estimation device estimates an interference signal component in a plurality of frequency bands in each instance.

13. The hearing apparatus as claimed in claim 9, wherein the microphone is a directional microphone based upon the interference sound components not originated from a useful sound direction are attenuated.

14. The hearing apparatus as claimed in claim 10, wherein the microphone is a directional microphone, and wherein the interference sound components not originated from a useful sound direction are attenuated based upon the directional microphone.

15. A method for a binaural supply of a user, comprising:
recording an input sound having a useful sound and an interference sound;
estimating the interference sound in the input signal; and
providing a first output signal based upon the estimated interference sound for a ear of the user and a second output signal based upon the estimated interference sound for a further ear of the user, wherein the second output signal has a time offset compared with the first output signal.

16. The method as claimed in claim 15, wherein the time offset is predeterminable.

17. The method as claimed in claim 15, wherein the time offset is artificial.

18. The method as claimed in claim 15, wherein a speech signal in the input signal is recognized as a useful sound based upon a speech recognition, and wherein the interference signal being estimated by the recognized speech signal being subtracted from the input sound.

19. The method as claimed in claim 16, wherein a speech signal in the input signal is recognized as a useful sound based upon a speech recognition, and wherein the interference signal being estimated by the recognized speech signal being subtracted from the input sound.

20. The method as claimed in claim 15, wherein an interference signal component is estimated in a plurality of frequency bands in each instance.

21. The method as claimed in claim 16, wherein an interference signal component is estimated in a plurality of frequency bands in each instance.

22. The method as claimed in claim 19, wherein an interference signal component is estimated in a plurality of frequency bands in each instance.

23. The method as claimed in claim 15, wherein interference sound components, which do not originate from a useful sound direction, are attenuated based upon a directional microphone.

24. The method as claimed in claim 20, wherein interference sound components, which do not originate from a useful sound direction, are attenuated based upon a directional microphone.

25. The method as claimed in claim 21, wherein interference sound components, which do not originate from a useful sound direction, are attenuated based upon a directional microphone.

26. The method as claimed in claim 22, wherein interference sound components, which do not originate from a useful sound direction, are attenuated based upon a directional microphone.
